(19) United States
(12) Patent Application Publication
(10) Pub. No.: US 2010/0092262 A1
(43) Pub. Date: Apr. 15, 2010

(54) MACHINE TOOL, AND METHOD FOR THE DAMPING OF OSCILLATORY MOVEMENTS OF A MACHINE ELEMENT OF A MACHINE TOOL

(75) Inventors: JENS HAMANN, Furth (DE); JÜRGEN KREJTSCHI, NURNBERG (DE); ELMAR SCHÄFERS, FURTH (DE); DIETMAR STOIBER, FURTH (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, München (DE)

(21) Appl. No.: 12/576,629

(22) Filed: Oct. 9, 2009

(30) Foreign Application Priority Data
Oct. 10, 2008 (EP) EP08017837

(51) Int. Cl. B23D 37/00; G05B 5/01; B23D 41/02

(52) U.S. Cl. 409/244; 318/623; 409/276

(57) ABSTRACT

A machine tool includes a first motor, a gear, and a machine element which is movable in a direction of movement by the first motor via the gear. A second motor is provided to apply a force directly upon the machine element in the direction of movement of the machine element in the absence of an interposed gear between the second motor and the machine element. The second motor is constructed to operate in such a way that the applied force counteracts an oscillatory movement of the machine element in the direction of movement of the machine element.

### CROSS-REFERENCES TO RELATED APPLICATIONS

This application claims the priority of European Patent Application, Serial No. EP08017837, filed Oct. 10, 2008, pursuant to 35 U.S.C. 119(a)-(d), the content of which is incorporated herein by reference in its entirety as if fully set forth herein.

### BACKGROUND OF THE INVENTION

The present invention relates to a machine tool, and to a method for the damping of oscillatory movements of a machine element of a machine tool.

The following discussion of related art is provided to assist the reader in understanding the advantages of the invention, and is not to be construed as an admission that this related art is prior art to this invention.

When machine elements of machine tools are not directly driven, the elasticity of the drive train as a consequence of the gear which is used induces oscillatory movements of the machine elements, especially in the range of the natural oscillation frequencies of the drive train. Using a direct drive can greatly reduce the elasticity of the drive train. However, the direct drive then also has to be designed such that all process requirements (machining and acceleration forces) are fulfilled. This is often not possible in practice in machine tools, since, on the one hand, it is markedly too cost-intensive and, on the other hand, the necessary number of direct drives which would be necessary in order to generate the often very high force required for moving the machine element during a machining operation cannot be integrated into the machine tool because of the high space requirement.

In commercially available machine tools, productivity losses arise as a result of this. Hence, for example in precision machining, a machine element, such as, for example, a machine table, has to be moved slowly in order to maintain the necessary high machining precision and to avoid oscillations occurring. Furthermore, however, even when finish-machining is being carried out, the machine element often has to be moved relatively slowly so that no natural oscillations are excited.

Various approaches have been tried to address oscillation damping, such as, for example, optimized stipulation of position desired values, suitable parameterization of speed governors or by means of anti-oscillators. All these approaches proved still to be inadequate and resulted in productivity losses in many applications, especially when high machining and acceleration forces occur.

It would therefore be desirable and advantageous to address prior art shortcomings and to damp oscillatory movements of a machine element of a machine tool.

### SUMMARY OF THE INVENTION

According to one aspect of the present invention, a machine tool includes a first motor, a gear, a machine element movable in a direction of movement by the first motor via the gear, and a second motor applying a force directly upon the machine element in the direction of movement of the machine element in the absence of an interposed gear between the second motor and the machine element, said second motor being constructed to operate in such a way that the applied force counteracts an oscillatory movement of the machine element in the direction of movement of the machine element.

According to another aspect of the present invention, a method for damping an oscillatory movement of a machine element of a machine tool includes the steps of moving the machine element in a direction of movement by a first motor, applying a force directly upon the machine element in the direction of movement of the machine element by a second motor in the absence of a gear interposed between the second motor and the machine element, and operating the second motor in such a way that the applied force counteracts an oscillatory movement of the machine element in the direction of movement of the machine element.

According to another advantageous feature of the present invention, the second motor may be designed as a linear motor or as a rotary motor. The linear motor or rotary motor operates hereby as a direct drive. Advantageously, the rotary motor may be designed as a torque motor. A torque motor makes it possible to generate a high torque and therefore a high force which acts upon the machine element, thus making high oscillation damping possible.

According to another advantageous feature of the present invention, the second motor may be operated in such a way that the applied force is proportional to a difference between a desired speed and an actual speed of the machine element. Especially good damping can thereby be implemented.

According to yet another advantageous feature of the present invention, the machine element can be designed as a machine table or as a machine slide. Designing the machine element as a machine table or as a machine slide constitutes a typical implementation of the machine element. However, the machine element may, of course, also be configured in the form of another element. Thus, for example, the machine element may also be designed in the form of a motor (for example, tool spindle motor) which serves for the rotary drive of a tool.

According to still another advantageous feature of the present invention, the machine tool may be constructed in the form of a broaching machine. In this type of machine tool in particular, high machining and acceleration forces arise.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a first exemplary embodiment of a machine tool according to the invention;

FIG. 2 is a block diagram of a control system for activating first and second motors,

FIG. 3 is a schematic illustration of a second exemplary embodiment of a machine tool according to the invention; and

FIG. 4 is a schematic illustration of a third exemplary embodiment of a machine tool according to the invention, with the machine tool being designed as a broaching machine.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

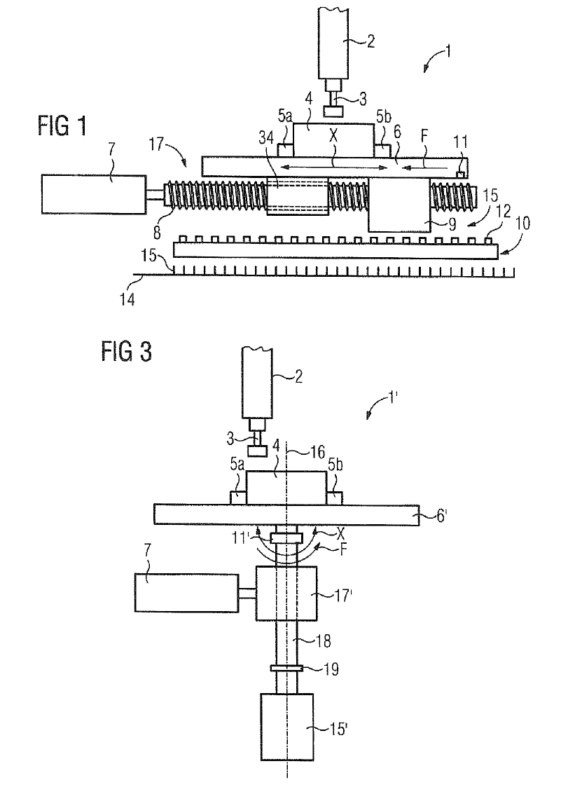

Turning now to the drawing, and in particular to FIG. 1, there is shown a schematic illustration of a first exemplary embodiment according to the invention of a machine tool 1, only the components of the machine tool 1 which are essential for understanding the invention being illustrated in FIG. 1. The machine tool 1 has a machine element 6 which in terms of the exemplary embodiment is designed in the form of a machine table. The machine element 6 is driven by a first motor 7. The first motor 7 in this case drives in rotation a spindle 8 which has a corresponding thread. A spindle nut 34, which has a counterthread fitting with the thread of the spindle, is connected fixedly to the machine element 6. When the first motor 7 rotates and therefore the spindle 8 rotates, the spindle nut 34 and consequently the machine element 6 are moved in the direction of movement X, that is to say, in terms of the exemplary embodiment, in a horizontal direction to the left or to the right, depending on the direction of rotation of the motor 7. The spindle nut 34 and the spindle 8 together form a gear 17. The machine element 6 can thus be moved in the direction of movement X via the gear 17 by means of the first motor 7.

A workpiece 4 is chucked on the machine element 6 by means of a workpiece holding fixture 5 which is fastened to the machine element 6. A third motor 2, which in terms of the exemplary embodiment is in the form of a tool spindle motor, drives a tool 3 (for example, a milling cutter) in rotation in order to machine the workpiece 4.

A position encoder 11 measures the actual position x_{act} of the machine element 6 with respect to a fixed scale 14 which is illustrated diagrammatically in FIG. 1 and which has increments, only one increment 31 being given a reference symbol for the sake of clarity. If, then, the machine element 6 is moved in the direction of movement X, high machining forces occur, for example in cutting machining, and act in the direction of movement X. The high force correspondingly necessary for moving the machine element 6 and consequently the workpiece 4 is generated by the first motor 7 via the gear 17. The gear 17 is necessary, since only via this is it possible to apply efficiently the high forces necessary for moving the machine element 6 during the machining operation.

The disadvantage of such a drive train is that, for example because of the thread backlash between the thread of the spindle and the internal thread of the spindle nut 34, this can easily be moved back and forth in the direction of movement X within a short distance, so that oscillatory movements of the machine element 6, especially in the range of the natural frequencies of the drive train, occur.

This is where the invention comes in. According to the invention, the machine tool 1 has a direct drive in the form of a second motor 15. In terms of this exemplary embodiment, the second motor 15 is designed in the form of a linear motor and consists of a primary part 9 which is connected fixedly to the machine element 6 and the coils of which are correspondingly activated electrically in order to generate a magnetic field, and of a fixed secondary part 10 which has permanent magnets, only one permanent magnet 11 being given a reference symbol in FIG. 1 for the sake of clarity. In terms of the exemplary embodiment, the primary part 9 is arranged in front of the spindle 8 in the view according to FIG. 1.

By means of the second motor 15, a force F acting directly upon the machine element 6 is exerted upon the machine element 6 in the direction of movement X of the latter. As already stated, according to the invention, the second motor 15 is designed as a direct drive, that is to say the second motor 15 is connected to the machine element 6 directly without a gear interposed between the second motor 15 and the machine element 6 and therefore, as already stated, exerts the force F directly upon the machine element 6 in the direction of movement X of the latter. The second motor 7 is in this case activated via a control unit in such a way that the force F generated by it counteracts oscillatory movements of the machine element 6 which run in the direction of movement X of the machine element 6, that is to say, for example, when the oscillatory movement takes place precisely in the X-direction from left to right, a positive force F is generated in the direction of the force F, as depicted by an arrow, and counteracts the movement from right to left, and, for example, when the oscillatory movement takes place precisely in the X-direction from right to left, a negative force F is generated in the direction of the force F, as depicted by an arrow, and counteracts the movement from left to right.

According to the invention, the second motor 15 does not have to apply the high movement force necessary for moving the machine element 6 during the machining operation, but merely has to apply the force F in order to damp the oscillatory movement of the machine element 6.

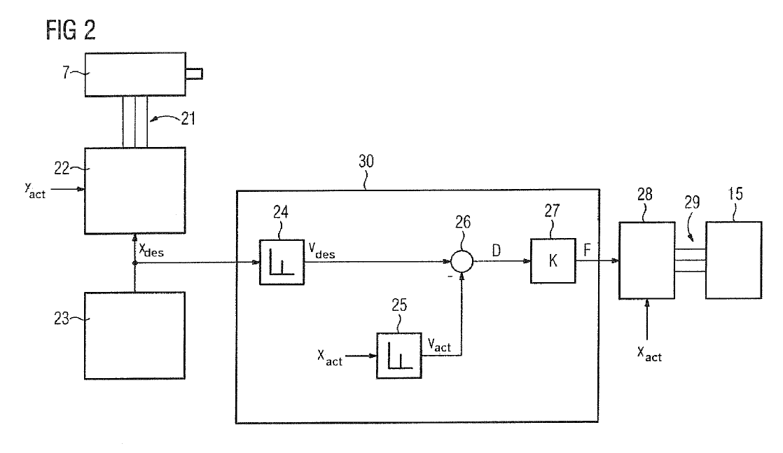

FIG. 2 illustrates an associated control system for activating the first motor 7 and the second motor 15. A control unit 23 (for example, the numerical control of the machine tool) generates a desired position x_{des} in the form of position desired values in order to activate the first motor 7. The desired position x_{des} is output as an input variable to a first drive unit 22. The first drive unit 22 has internally essentially a current converter and regulating functionalities. The first drive unit 22 is connected to the first motor 7 via electrical lines 21 for the activation of the first motor 7. To regulate the position of the machine element 6, the drive unit 22 receives, as a controlled actual input variable, the actual position _{xact}, measured by the position encoder 11, of the machine element 6 in the form of position actual values. The machine element 6 is then moved in the direction of movement X to the desired position x_{des} correspondingly to the desired position x_{des} stipulated by the control unit 23.

Moreover, the control system has a regulating unit 30 which has two differential quotient calculation function modules 24 and 25, a subtractor 26 and a controller 27 in order to calculate the differential quotient in terms of the time t. The desired position x_{des} is output by the control unit 23 to the differential quotient calculation function module 24 which, by derivation in terms of the time t, calculates a desired speed v_{des} from the desired position x_{des} and outputs this on the output side. By means of the differential quotient calculation function module 25, an actual speed v_{act} is calculated, by means of derivation in terms of the time t, from the actual position x_{act} measured by the position encoder 11. Subsequently, by means of the subtractor 26, the difference D between the desired speed v_{des} and the actual speed v_{act} is calculated and is delivered as an input variable to the controller 27 which in terms of the exemplary embodiment is designed as a proportional controller. The controller 27 determines the force F which is to be exerted by the second motor 15 in order to damp the oscillatory movements of the machine element 6 by multiplying the difference D by a factor K and outputs the force F to a second drive unit 28 as an input variable. The second drive unit 28 is connected to the second motor 15 of the machine tool 1 via electrical lines 29. The second drive unit 28 generates electrical output voltages along the lines 29 according to the force F stipulated by the controller 27 and according to the actual position x_{act} in such a way that the second motor 15 generates the force F and exerts it upon the machine element 6.

FIG. 3 illustrates in the form of a diagrammatic illustration a further exemplary embodiment in the form of the machine tool 1′. The embodiment illustrated in FIG. 3 corresponds in its basic set-up essentially to the embodiment described above in FIG. 1. Identical elements are therefore given the same reference symbols in FIG. 3 as in FIG. 1. The essential difference from the embodiment according to FIG. 1 is that, in the embodiment according to FIG. 3, the machine element 6′ is designed as a machine table in the form of what is known as a rotary table, which can be moved rotatably about the axis of rotation 16 in the X-direction. In contrast to the exemplary embodiment according to FIG. 1, therefore, the direction of movement X is not translational, as in FIG. 1, but rotational. The position encoder 11′ measures the actual position, that is to say the angle of rotation of the machine element 6′. The first motor 7 drives the machine element 6′ in rotation via a gear 17′ which drives a drive shaft 18. The drive shaft 18 is connected fixedly to the machine element 6. Furthermore, the drive shaft 18 is connected via a screw connection 19 to the second motor 15′ which, in terms of this exemplary embodiment, is designed as a rotary motor, in particular as what is known as a torque motor. The machine element 6′ can be moved in the direction of movement X via the gear 17′ by means of the first motor 7. The second motor 15′ exerts the force F upon the machine element in the direction of movement X which in terms of this exemplary embodiment is rotational. Thus, as in the exemplary embodiment according to FIG. 1, the second motor 15′ exerts the force F upon the machine element 6′ directly without a gear interposed between the second motor 15′ and machine element 6′.

The activation of the second motor 15′ according to FIG. 3 takes place in a similar way via the control system illustrated and described in FIG. 2. The functioning of the embodiment according to FIG. 3 otherwise corresponds to the functioning of the embodiment according to FIG. 1.

It may be noted at this juncture that a reduction in the wear of the machine tool is also achieved by means of the oscillation damping achieved by virtue of the invention.

Furthermore, it may be noted at this juncture that the machine element does not, of course, necessarily have to be designed as a machine table as in the exemplary embodiments, but may be in the form of any machine element of the machine tool. Thus, the machine element may, for example, also be in the form of the third motor 2 which can be moved in a similar way by means of the drive system described and the oscillatory movements of which can be damped, or, for example, may also be in the form of a moveable machine slide which can be moved in a similar way by means of the drive system described and oscillatory movements of which can be damped.

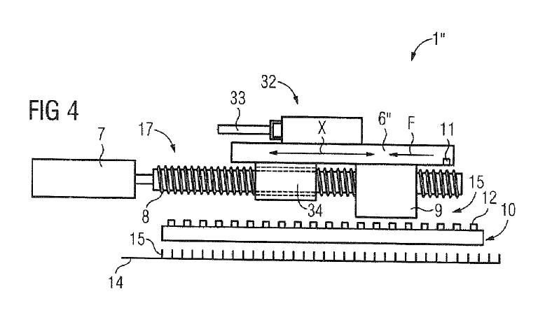

FIG. 4 illustrates in the form of a diagrammatic illustration a machine tool designed as a broaching machine 1″, only the components essential for understanding the invention being illustrated. The embodiment illustrated in FIG. 4 corresponds in its basic set-up essentially to the embodiment described above in FIG. 1. Identical elements are therefore given the same reference symbols in FIG. 4 as in FIG. 1. The essential distance from the embodiment according to FIG. 1 is that, in the embodiment according to FIG. 4, the machine element 6″ is designed as a moveable machine slide, to which a tool holding fixture 32 is fastened. A broaching tool 33, which, for example, may be in the form of a broaching cutter bar, is chucked in the tool holding fixture. With the aid of the broaching tool 33, a workpiece, not illustrated in any more detail in FIG. 4 for the sake of clarity, is broached. The embodiment according to FIG. 4 otherwise corresponds in functioning to the embodiment according to FIG. 1.

Furthermore, it may be mentioned at this juncture that it is also possible to achieve a damping of oscillatory movements of the machine component 6 by the oscillatory movements being damped passively by means of an eddy current brake. For this purpose, for example, the primary part 9 can be cast with copper and thus short-circuited. In conjunction with the secondary part 10 therefore, a passively operating eddy current brake is obtained. This solution has the disadvantage, as compared with the solution according to the invention, that the damping which can be implemented is markedly lower, and the damping cannot be adjusted after the eddy current brake has been installed.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A machine tool, comprising:
a first motor;
a gear;
a machine element movable in a direction of movement by the first motor via the gear; and
a second motor applying a force directly upon the machine element in the direction of movement of the machine element in the absence of an interposed gear between the second motor and the machine element, said second motor being constructed to operate in such a way that the applied force counteracts an oscillatory movement of the machine element in the direction of movement of the machine element.

2. The machine tool of claim 1, wherein the second motor is designed as a linear motor.

3. The machine tool of claim 1, wherein the second motor is designed as a rotary motor.

4. The machine tool of claim 3, wherein the rotary motor is designed as a torque motor.

5. The machine tool of claim 1, wherein the second motor is operated in such a way that the applied force is proportional to a difference between a desired speed and an actual speed of the machine element.

6. The machine tool of claim 1, wherein the machine element is designed as a machine table.

7. The machine tool of claim 1, wherein the machine element is designed as a machine slide.

8. The machine tool of claim 1, constructed in the form of a broaching machine.

9. A method for damping an oscillatory movement of a machine element of a machine tool, said method comprising the steps of:
moving the machine element in a direction of movement by a first motor;
applying a force directly upon the machine element in the direction of movement of the machine element by a second motor in the absence of a gear interposed between the second motor and the machine element; and
operating the second motor in such a way that the applied force counteracts an oscillatory movement of the machine element in the direction of movement of the machine element.
